(19) United States
(12) Patent Application Publication
(10) Pub. No.: US 2009/0167941 A1
(43) Pub. Date: Jul. 2, 2009

(54) VIDEO DATA RECEPTION APPARATUS AND VIDEO DATA TRANSMISSION AND RECEPTION SYSTEM

(75) Inventor: Hideki TAKEDA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/326,469

(22) Filed: Dec. 2, 2008

(30) Foreign Application Priority Data
Dec. 28, 2007 (JP) 2007-340788

(51) Int. Cl. H04N 7/00

(52) U.S. Cl. 348/474; 348/E07.001

(57) ABSTRACT

A video data reception apparatus is provided including a position information detection unit configured to detect position information on a frame/field of a video data signal with reference to a synchronizing signal synchronous with the video data signal inputted thereto with information superposed on the video data signal, the information being specific data of at least one of an effective video data area, a frame/field frequency and a parameter for video process; and an information acquisition unit configured to acquire information on the specific data from the video data signal using the position information. The information acquisition unit can start at least one of signal processing such as the extraction of an effective video data area in the video data signal using the information on the specific data, by the following frame or field where the information acquisition unit acquires information on the specific data.

### CROSS REFERENCE TO RELATED APPLICATION

This application is based upon and claims the benefit of priority from the prior Japanese Patent Application No. 2007-340788 filed on Dec. 28, 2007; the entire contents of which are incorporated herein by reference.

### BACKGROUND OF THE INVENTION

1. Field of the Invention

The present invention relates to a video data reception apparatus and a video data transmission and reception system that receive a video data signal on which specific information is superposed.

2. Description of the Related Art

A signal forming an interface mediating the transmission of a general video data is composed of a clock signal and video data signal. The signal can further include a horizontal synchronizing signal, a vertical synchronizing signal and a field index signal. The signal can still further include a data enable signal.

Synchronous information is transmitted with the horizontal and the vertical synchronizing signal or included in a data signal in a form of a start of active video (SAV) and an end of active video (EAV) specified by ITU-R BT.656. The latter does not require the horizontal and the vertical synchronizing signal.

The video data is sent every clock on a pixel basis in the order of the raster scan from a left upper pixel in each frame (or, a field, hereinafter, the frame includes also the field).

The vertical synchronizing signal is asserted at the head of the frame and the horizontal synchronizing signal is asserted at the head of each line. Since the cycle of a synchronizing signal is determined by a video format, the horizontal and the vertical synchronizing signal are detected on the reception side to enable the video format to be identified and the horizontal and the vertical coordinate position to be determined in the frame of the received video data as long as a normal signal transfer is conducted.

Each frame has an effective data area and a blanking data area except the effective data area and the position of each area is different depending on the video format. For this reason, if the video format is changed on the transmission side, the reception side needs to know the changed effective data area by some sort of means.

Furthermore, while the video format remains unchanged, the effective data area can be changed at the transmission-side's convenience. In that case, the reception side needs to know the changed effective data area as well.

The effective data area further can be dynamically changed. In order to promptly cope with this, the reception side is desired to recognize the information on the effective data area in real time in synchronization with the switching of the effective data area.

If that is not normally done, neither the effective data area can be correctly extracted nor the video data can be seamlessly processed.

As one of the methods of transmitting the effective data area, there is a known method of performing communication using an interface different from video data communication. A video transmission module and an LSI including the video transmission module, and a video reception module and an LSI including the video reception module are mostly connected to various types of buses configured to control them.

The method transmits the effective data area information obtained by the video transmission module to the video reception module through the bus such as a PCI bus or a processor bus.

The bus is general and has an advantage in that information except the effective data area can be transmitted at the same time.

However, it is difficult to transfer the change of the effective data area in synchronization with data because a transmission path is independent of the video data, and because it normally takes much time to transfer due to the intervention of a software and dispersion is caused. For this reason, it is difficult for the reception side to promptly cope with the change in the effective data area, so that the video output is muted (blacked out) before and after the change, during which switching is performed.

A prior example using such a transfer system is disclosed in Japanese Patent Application Laid-Open Publication No. 2007-13464.

The prior example has a plurality of signal processing units configured to process an inputted video signal and output it to a display device. If an event occurs that the video signal to be outputted to the display device is switched from a first video signal to a second video signal inputted from a terminal different from the input terminal of the first video signal, an output controlling unit performs control so that the first video signal processed by the other signal processing unit is successively outputted to the display device until one signal processing unit ends processing at least the second video signal.

Thus, the prior example realizes an apparatus capable of switching a displayed video in a constant, short blanking time or a freezing time if a difference in input signal occurs.

As another transmission method, there is a known method of superposing information from which change in the effective data area is recognized during a period outside the effective area of a video data signal, for example, during the blanking period. On recognizing a change point, the reception side temporarily mutes the video output.

The changed effective data area is transmitted in the same method as described above and the muting is released after the renewing of the effective data area is completed. The muting can be started at the moment that the effective data area is dynamically switched, so the muting period can be made shorter than that in the above method; however, the muting is still required.

As still another transmission method, there is a method of transmitting video data with a data enable signal. The data enable signal is transmitted in synchronization with the video data and indicates directly valid or invalid. Even if the effective data area is dynamically changed, the effective data can be extracted and even if the effective data is intermittently transmitted, it is also possible to cope with.

The method, however, requires a single dedicated signal line and can transmit only information indicating valid or invalid. Since data and information indicating valid or invalid are received at the same time, it is impossible to transmit information about the effective data area in advance, making it difficult to continuously perform a video process such as scaling.

The above deals with the effective data area information representing the effective data area as specific information desired to be acquired on the video data reception apparatus side. But, the same problem arises even in the case where a frame frequency is changed (or switched) instead of the effective data area or a parameter is changed at the time of video process.

### SUMMARY OF THE INVENTION

A video data reception apparatus according to one attitude of the present invention includes: a position information detection unit configured to detect position information on a frame or a field of a video data signal with reference to a synchronizing signal synchronous with the video data signal, the video data signal being inputted to the position information detection unit with information superposed on the video data signal, the information being on specific data of at least one of an effective video data area, a frame or a field frequency and a parameter for video process; and an information acquisition unit configured to acquire information on the specific data from the video data signal using the position information; wherein the information acquisition unit is capable of starting at least one piece of signal processing of the extraction of an effective video data area in the video data signal, the change of the frame or the field frequency and the change of a parameter for video process, using the information on the specific data acquired by the information acquisition unit, during the frame or the field, or by the following frame or field with respect to which the information acquisition unit acquires information on the specific data.

A video data reception apparatus according to another attitude of the present invention includes: a position information detection unit configured to detect position information on a frame or a field of a video data signal with reference to a synchronizing signal synchronous with the video data signal, the video data signal being inputted to the position information detection unit with information superposed on the video data signal, the information being on specific data of at least one of an effective video data area and a parameter for video process; and an information acquisition unit configured to acquire information on the specific data from the video data signal using the position information; wherein the information acquisition unit is capable of starting at least one piece of signal processing of the extraction of an effective video data area in the video data signal and the change of a parameter for video process using the information on the specific data acquired by the information acquisition unit during the frame or the field with respect to which the information acquisition unit acquires information on the specific data.

A video data transmission and reception system according to one attitude of the present invention includes: a video data transmission apparatus configured to transmit a synchronizing signal and a video data signal synchronous with the synchronizing signal, the video data signal being superposed to a predetermined position thereof with information of specific data of at least one of an effective video data area, a frame or a field frequency and a parameter; a video data reception apparatus configured to receive the video data signal transmitted from the video data transmission apparatus;

a position information detection unit configured to form the video data reception apparatus and detect position information on a current video data signal with reference to the synchronizing signal from the received video data signal; and an information acquisition unit configured to acquire information on the specific data from the received video data signal using the position information; wherein the information acquisition unit is capable of starting at least one piece of signal processing of the extraction of an effective video data area in the video data signal, the change of the frame or the field frequency and the change of a parameter, using the information on the specific data acquired by the information acquisition unit, during the frame or the field, or by the following frame or field with respect to which the information acquisition unit acquires information on the specific data.

### BRIEF DESCRIPTION OF THE DRAWINGS

FIG. 1 is a block diagram illustrating the configuration of a video data transmission and reception system equipped with a video data reception apparatus according to a first embodiment of the present invention;

FIG. 2 is a diagram illustrating one example of each field of a video data format;

FIG. 3 is a block diagram illustrating the configuration of a reception module as the video data reception apparatus according to the first embodiment of the present invention;

FIG. 4A is a diagram describing the operation in which an extraction process in an effective data area is seamlessly performed in synchronization with a frame in the first embodiment;

FIG. 4B is a diagram describing the operation in a period in the vicinity where the (N-1)-th frame is switched to the N-th frame in FIG. 4A;

FIG. 5 is a block diagram illustrating the configuration of a reception module according to a second embodiment of the present invention;

FIG. 6 is a block diagram illustrating the configuration of a video data transmission and reception system equipped with a video data reception apparatus according to a third embodiment of the present invention;

FIG. 7 is a block diagram illustrating the configuration of a reception module according to the third embodiment of the present invention; and

FIG. 8 is a block diagram illustrating the configuration of a reception module according to a modified example of the third embodiment.

### DETAILED DESCRIPTION OF THE PREFERRED EMBODIMENTS

Embodiments of the present invention are described below with reference to the drawings.

### First Embodiment

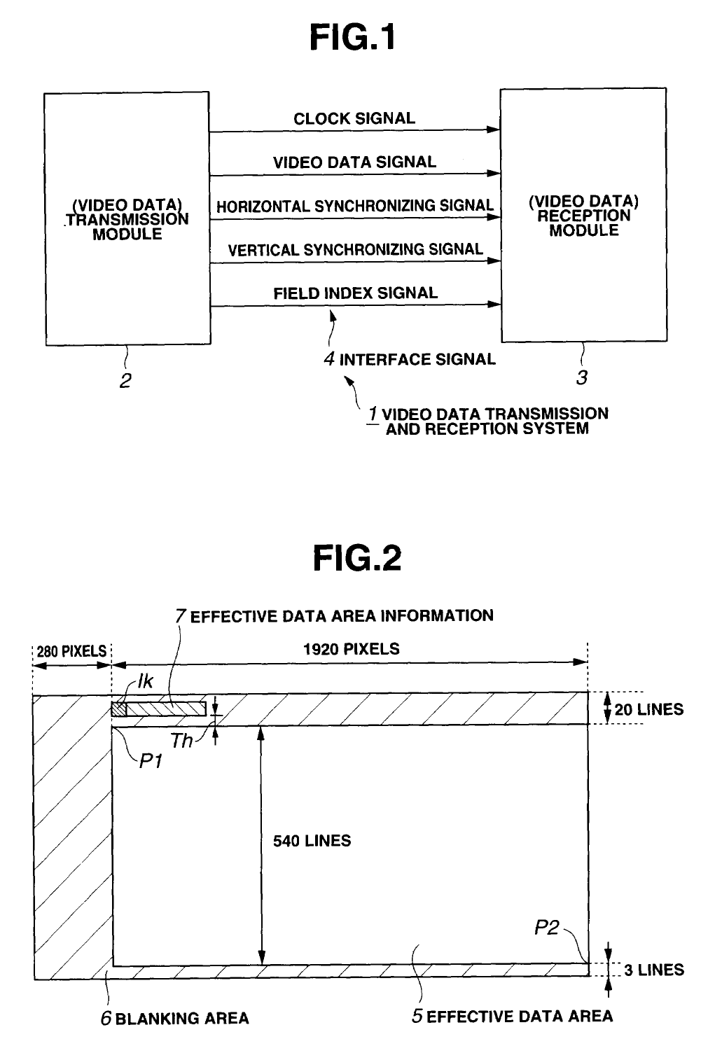

FIG. 1 is a block diagram illustrating the configuration of a video data transmission and reception system equipped with a video data reception apparatus according to a first embodiment of the present invention.

The video data transmission and reception system 1 includes a video data transmission module (hereinafter abbreviated as “transmission module”) 2 as a video data transmission apparatus configured to transmit a video data signal and a video data reception module (hereinafter abbreviated as “reception module”) 3 as a video data reception apparatus configured to receive a video data signal, which are connected by an interface signal 4 intervening between the transmission module 2 and the reception module 3.

In the present embodiment, the interface signal 4 transmitting a signal from the transmission module 2 to the reception module 3 is formed of a clock signal, a video data signal, a horizontal synchronizing signal, a vertical synchronizing signal and a field index signal representing a field index.

In FIG. 1, the video data signal, the horizontal synchronizing signal, the vertical synchronizing signal and the field index signal are separately transmitted, however, the synchronizing signals may be superposed on the video data signal.

When the synchronizing signals superposed on the video data signal are transmitted, all or any of the horizontal synchronizing signal, the vertical synchronizing signal and the field index signal do not exist sometimes.

FIG. 2 illustrates one example of a first field in a video data format transmitted from the transmission module 2 to the reception module in the present embodiment.

The transmission module 2 transmits a signal generated by raster scanning each pixel forming video data of each frame (here, a field) illustrated in FIG. 2 pixel by pixel in the horizontal direction from the left upper corner in synchronization with the clock signal to the reception module 3 as a video data signal.

The term raster scan refers to a scanning system in which scanning starts at the left end on the uppermost line, moves rightward one by one, reaches the right end, then moves from the left end of the second top line to the right end and similarly moves to the bottom line in the order.

The vertical synchronizing signal is asserted (or inserted) at the head of each field and the horizontal synchronizing signal is asserted at the head of each line. Since the cycles of both synchronizing signals are determined by a video format, the horizontal and the vertical synchronizing signal are detected on the reception module 3 side to enable the video format to be identified as long as a normal signal transfer is conducted.

The horizontal and the vertical coordinate position in each field of the video data signal received at that time can also be determined.

As illustrated in FIG. 2, each field of each video data is composed of an effective (video) data area 5 as an area where an actually displayed video (image) is effectively displayed and a blanking area 6 being an area excluding the effective data area 5.

In the present embodiment, effective data area information 7 representing the effective data area 5 is superposed as information on specific data corresponding to the standard and specifications of the video data in a predetermined position of, for example, the blanking area 6 excluding the effective data area 5 in the video data signal.

As illustrated in FIG. 2, the effective data area information 7 is set to a predetermined position (coordinate position) being temporally preceding the head of the effective data area 5 (i.e., the upper left corner of the effective data area 5) as timing of transmitting the video data.

The transmission timing of the effective data area information 7 is set at a predetermined timing prior to the timing when the transmission of the head part of the effective data area 5 is started.

The reception module 3 acquires (detects) the effective data area information 7 at a predetermined timing in the inputted video data signal to enable the effective data area 5 to be calculated before the effective data area 5 is received (inputted).

One example of the effective data area information 7 is information on both coordinate positions of a coordinate position P1 of the starting point (head) at the upper left and a coordinate position P2 of the ending point at the lower right in the effective data area 5. Both coordinate positions allow the effective data area 5 to be determined in FIG. 2, for example.

The effective data area information 7 can be represented by combining the two coordinate positions as one example. If the effective data area 5 is plural, combinations equal in number to the effective data area 5 may be prepared to equate (match) the position and specifications of superposed information between the transmission and the reception sides.

In the example in FIG. 2, the effective data area information 7 is acquired (as information on specific data), then the starting and the ending points of the effective data area 5 are recognized (discriminated) and the extraction process of the effective data area 5 is performed (from the head of the effective data area 5) in real time at the timing when the head of the effective data area 5 is inputted based on information on the recognition result. Incidentally, in a second embodiment described later, the extracted effective data area 5 can be subjected to video process in real time.

For this reason, the position of the effective data area information 7 is set so as to be advanced by a period (Th in FIG. 2) equivalent to several horizontal periods with respect to the coordinate position P1 of the starting point of the effective data area 5, and transmission and reception are performed.

The period Th can be made shorter than several horizontal periods. If the period Th is set to, for example, one horizontal period or longer, a margin for time delay until a corresponding process is performed after the effective data area information 7 is acquired can be ensured. For such information that a screen frequency (i.e., a field or a frame frequency), is switched as information on specific data, as described later, the blanking area 6 is available below the effective data area 5.

In the example of FIG. 2, the position of the effective data area information 7 is indicated in the example of a first field with 2200 pixels in the horizontal direction and 563 pixels in the vertical direction. Setting the position of the effective data area information 7 to a predetermined position common to other video formats, i.e., to a position where the predetermined position is not changed in any video format, makes it easy to detect the effective data area information 7.

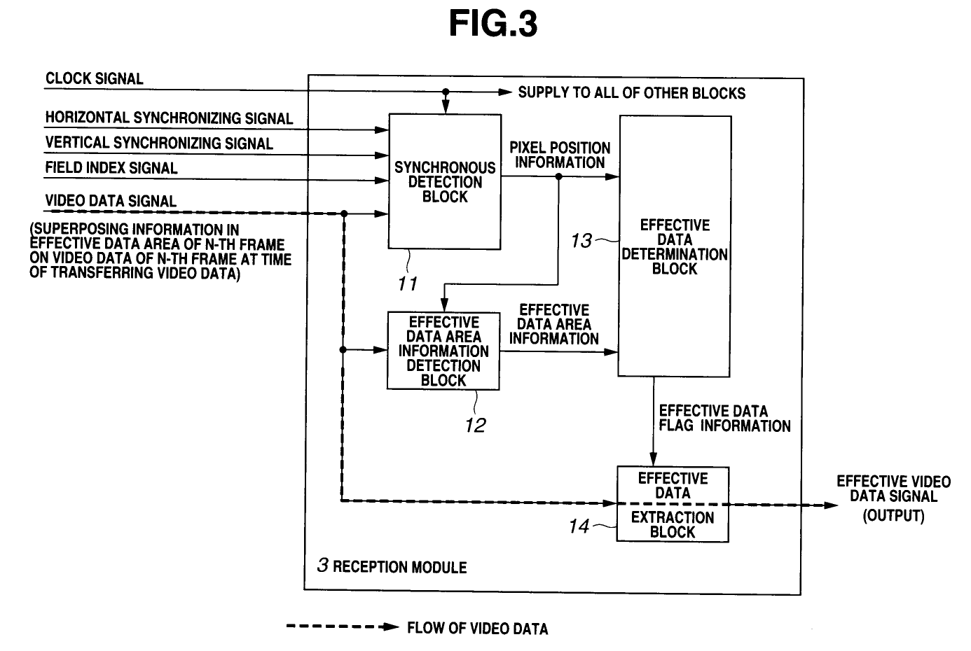

FIG. 3 illustrates a concrete configuration of the reception module 3 in FIG. 1.

The reception module 3 includes a synchronous detection block 11 being a position information detection unit configured to detect the position of each pixel on a frame or a field of the video data, an effective data area information detection block 12 (being an information acquisition unit) configured to detect (or acquire) the effective data area information 7, an effective data determination block 13 configured to determine as to whether each pixel is an effective data and an effective data extraction block 14 configured to perform a signal processing to extract an effective data.

To the synchronous detection block 11, the clock signal, horizontal synchronizing signal, vertical synchronizing signal, field index signal and video data signal are inputted.

The synchronous detection block 11 detects horizontal, vertical and field information from various synchronizing signals (or synchronous information superposed on the video data signal) composed of the horizontal and vertical synchronizing signals and field index signal inputted in synchronization with the video data signal.

The synchronous detection block 11 refers to the clock signal synchronized with both the synchronizing signals to obtain pixel position information as a (coordinate) position information on a field or a frame of the video data signal (or a pixel forming the video data signal) at the input time (the present time if the input time is at present).

The pixel position information detected by the synchronous detection block 11 is outputted to the effective data area information detection block 12 and the effective data determination block 13.

The video data signal is also inputted to the effective data area information detection block 12. The clock signal is supplied to all blocks illustrated in FIG. 3.

The effective data area information detection block 12 detects or acquires the effective data area information 7 inputted at a predetermined timing corresponding to the predetermined position illustrated in FIG. 2 using the pixel position information detected by the synchronous detection block 11. More specifically, the effective data area information detection block 12 forms an information acquisition unit configured to acquire the effective data area information 7 as information on specific data.

The effective data area information detection block 12 includes a window-type comparison circuit configured to compare, for example, the pixel position information with information in a predetermined position and a gate circuit whose gate is rendered turned off and then turned on by the comparison result of the comparison circuit to acquire the effective data area information 7.

The effective data area information detection block 12 recognizes the detected or the acquired effective data area information 7 as information on the effective data area 5.

As described above, setting the coordinate positions P1 and P2 of the starting and the ending points of the effective data area 5, for example, as the effective data area information 7 causes the effective data area information detection block 12 to recognize both coordinate positions P1 and P2. The effective data area information detection block 12 outputs information on both coordinate positions P1 and P2 as the recognized effective data area information to the effective data determination block 13. If the effective data area information 7 is encoded, it is decoded.

The effective data area information detection block 12 may output the acquired effective data area information 7 to the effective data determination block 13 without recognizing it, and the effective data determination block 13 may recognize the effective data area information 7 (and decodes if it is encoded).

The effective data determination block 13 determines as to whether the video data in the current frame is effective, from the pixel position information on the video data obtained by the synchronous detection block 11 and the effective data area information obtained by the effective data area information detection block 12.

If it is determined that the video data is effective, the effective data determination block 13 outputs to the effective data extraction block 14 an effective data flag information indicating that the video data is effective for (each pixel of) the video data in the effective data area 5, for example.

The effective data determination block 13 outputs flag codes of one (1) for (each pixel of) the video data in the effective data area 5, for example, or zero (0) for (each pixel of) the video data outside the effective data area 5 as effective data flag information.

The video data extraction block 14 also receives the video data signal including the blanking area 6 and extracts the video data in the effective data area 5 in real time according to the effective data flag information. The flow of (pixels of) video data in the video data signal is indicated with a thick dotted line in FIG. 3.

In this case, the effective data determination block 13 outputs the effective data flag information such that the effective data flag information for the pixels of the video data is also inputted to the effective data extraction block 14 at a timing synchronous with each pixel of the video data of the video data signal inputted to the effective data extraction block 14, more specifically, in synchronization with the clock signal.

For this reason, if the inputted video data signal is the pixels of the video data in the effective data area 5, the effective data extraction block 14 forms a signal processing unit configured to extract the pixels of the video data in real time and outputs the video data signal including only the extracted effective video data as the effective video data signal.

The effective video data signal outputted from the reception module 3 is supplied to a video processing module and a storage device such as a memory provided at the rear stage and used for display in a display apparatus (not shown).

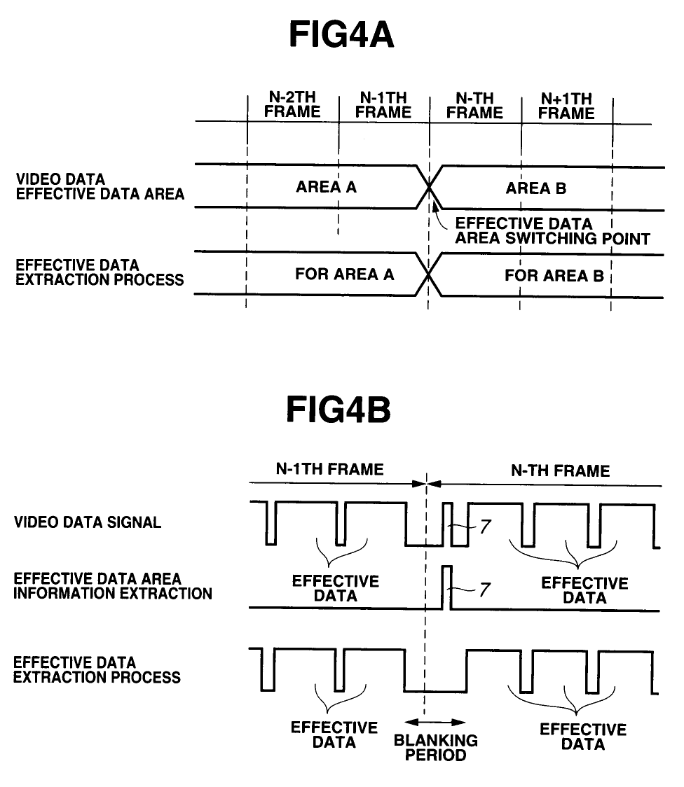

FIG. 4A is a diagram describing operation in the present embodiment in the case where, for example, the video data format in FIG. 2 is switched to another video data format.

The example of FIG. 4A shows that the effective data area lies in an area A until a frame reaches the (N-1)-th frame and the effective data area is changed to an area B in the N-th frame.

In this case, information in the area A as the effective data area 5 is superposed on a predetermined position in the blanking area 6 until the frame reaches the (N-1)-th frame (the second field of the (N-1)-th frame in FIG. 2), so that the information is extracted. The effective data in the area A is extracted using the extracted information. FIG. 4A illustrates the effective data extraction process for the area A.

Information in the area B as the effective data area 5 is superposed on a predetermined position in the blanking area 6 when the frame reaches the N-th frame (the first field of the N-th frame), so that the information in the area B is extracted.

After the extraction of the information, the video data in the effective data area 5 in the area B related to the information starts being inputted from the head thereof.

In the case where the effective data area 5 is thus changed, the information is extracted before the changed effective data area is actually inputted, so that a signal processing for the change in the effective data area 5 can be quickly or seamlessly carried out, for example.

More specifically, as illustrated in FIG. 4A, a switching point in the effective data area 5 can serve to seamlessly switch from the (N-1)-th frame into the N-th frame. In this case, before the area B is inputted as the effective data area 5 in the first field of the N-th frame, the information in the area B can be extracted during the blanking period, so that the signal processing can be seamlessly carried out.

In the period of the effective data area 5 in the area B, the signal can be extracted in real time. Therefore, even if the effective data area 5 is dynamically changed, an adaptation can be quickly made to the change.

FIG. 4B is an enlarged view describing the operation in the period in the vicinity where the (N-1)-th frame is switched to the N-th frame.

The effective data area 5 of the video data signal is changed (for example, made slightly smaller) from (N-1)-th frame to the N-th frame. Information on change in the effective data area 5 at that point is superposed on the effective data area information 7 during the blanking period of the N-th frame. In FIG. 4B, the signal period of the effective data area in the video data signal is shown as H-level effective data.

The effective data area information 7 is extracted by the effective data area information detection block 12 as illustrated in FIG. 4B. The effective data area information detection block 12 recognizes the starting and the ending points in the area B and sends the information to the effective data determination block 13.

The effective data determination block 13 receives the information, updates previous information, determines from the updated information whether the video data is effective and outputs flag information on the determination result to the effective data extraction block 14. The new flag information is executed before the head of a first effective data in the N-th frame is inputted.

Accordingly, inputting the effective data in the effective data area 5 (of the N-th frame) after the flag information causes the effective data extraction block 14 to seamlessly extract the effective data as illustrated by the effective data extraction process in FIG. 4B.

According to the present embodiment, even if the effective data area 5 of the video data in the video data signal is changed, the present embodiment can quickly adapt to the change of the effective data area 5.

In other words, if the effective data area 5 is changed, the video process for the effective data can be performed in real time (or seamlessly) without being interrupted (for example, until the following frame).

Thus, according to the present embodiment, if the effective data area in the video data signal is changed, the present embodiment can quickly acquire the changed information and adapt to the change.

In the present embodiment, although information on the effective data area 5 can be acquired before the video data in the effective data area 5 is inputted, the present invention is not limited to the above case, but the information may be acquired before the following frame is started.

In that case, the extraction of the effective data in the effective data area 5 can be started in at least (or at the latest) the following frame of the frames that have acquired information on the effective data area 5 and the extraction can be completed by the end of the frame.

In that case also, the extraction of the effective data can be started by at least the following frame of the frames that have acquired information, which also brings about an effect of quickly adapting to a change in the effective data area 5.

Although a frame, for example, is used in FIGS. 4A and 4B, a field can also be used similarly.

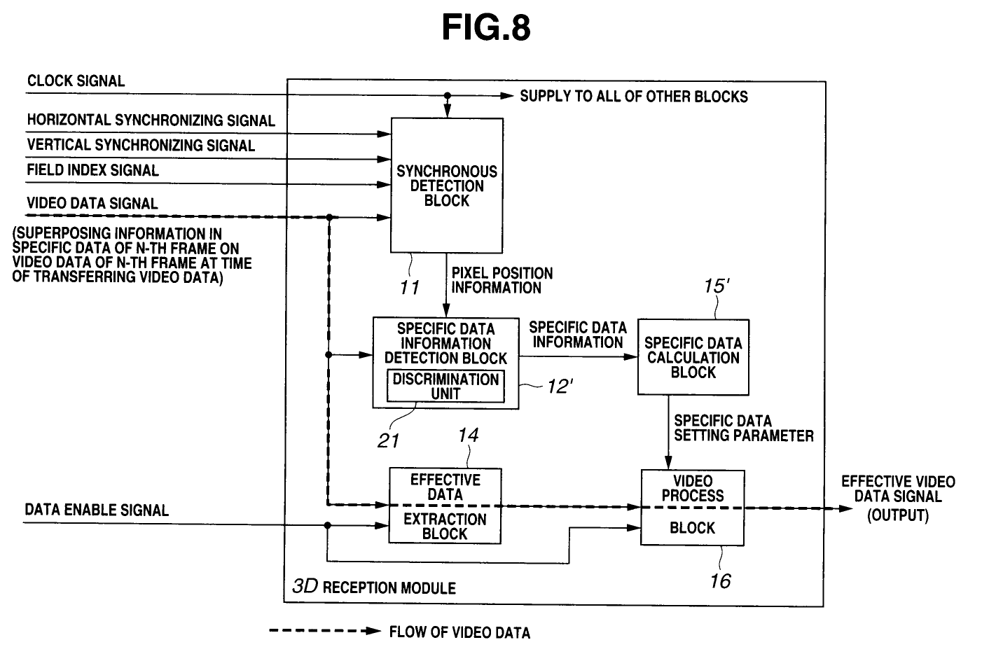

As described in FIG. 8, the transmission module 2 may transmit a different kind of information except the effective data area 5 as information on specific data. The transmission module 2 may also transmit a plurality of different kinds of information.

In such a case, in order for the reception side to facilitate adaptation, the transmission module 2 may add a kind code Ik representing a kind (of information on specific data) being information on the effective data area 5 to the video data and transmit the data, as the effective data area information 7 (described as the effective data area information 7 at the time of transmission) illustrated in FIG. 2.

In that case, the information acquisition unit such as the effective data area information detection block 12 on the reception side may be provided with a discrimination unit (reference numeral 21 in FIG. 8) configured to discriminate a corresponding kind of specific data when receiving the kind code Ik.

In that case, the discrimination unit is equipped with a data storage unit such as a lookup table (abbreviated as LUT) storing the kind code Ik associated with the corresponding kind of specific data in advance. When the discrimination unit acquires the kind code Ik, the unit refers to LUT to discriminate the kind of specific data.

Alternatively, the kind code is not used for one kind of information on specific data being default such as information in the effective data area 5 and the kind code added to other kinds of information is transmitted, thereby the reception side may discriminate (recognize) the kind of the transmitted information from the kind code.

### Second Embodiment

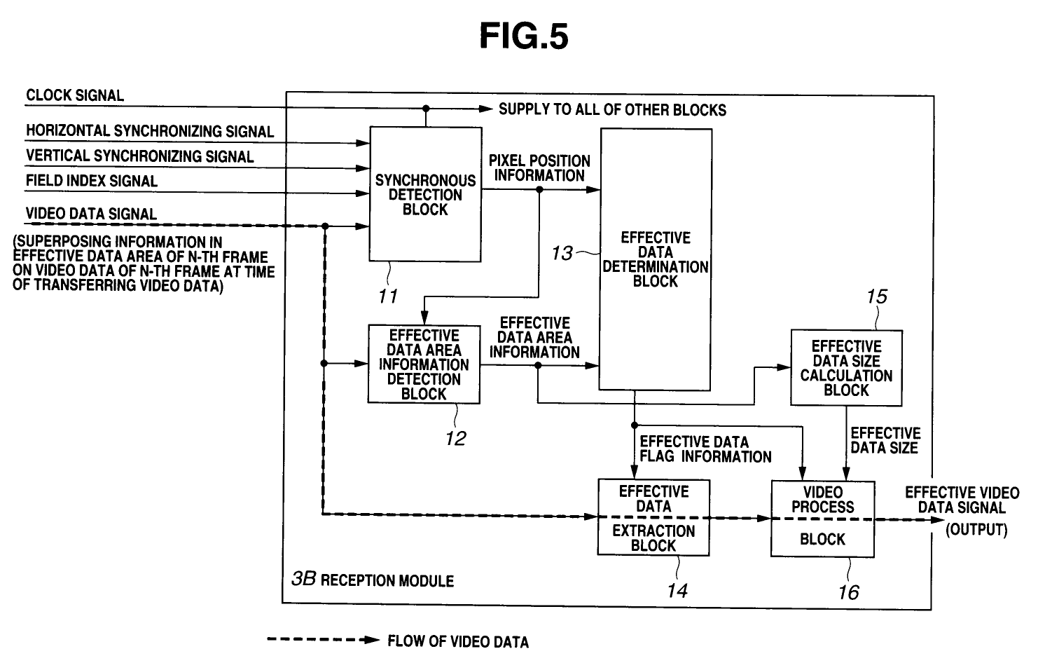

A second embodiment of the present invention is described below. FIG. 5 is a block diagram illustrating the configuration of a reception module 3B according to a second embodiment of the present invention. The interface signal between the transmission and the reception modules is the same as in the first embodiment.

The reception module 3B further adds an effective data size calculation block 15 and a video process block 16 to the configuration of the reception module 3 in FIG. 3.

The synchronous detection block 11, the effective data area information detection block 12, the effective data determination block 13 and the effective data extraction block 14 operate in the same manner as in the first embodiment.

To the effective data size calculation block 15, effective data area information extracted by the effective data area information detection block 12 is inputted.

The effective data size calculation block 15 calculates an effective data size required for a video process at the video process block 16 from the effective data area information and outputs the effective data size information to the video process block 16.

To the video process block 16 are inputted the effective data flag information, the effective data size information and the effective video data signal extracted by the effective data extraction block 14.

The video process block 16 subjects the effective video data extracted by the effective data extraction block 14 to the video process using the effective data flag information and the effective data size information. In that case, a determination as to whether the inputted video data is effective is made using the determination result obtained by the effective data determination block 13.

The video process performed by the video process block 16 includes a filter processing such as scaling.

As is the case with the first embodiment, the video process can be performed in real time (or seamlessly) when the effective data area information 7 is acquired and then the head of the effective data area 5 in the same field or frame is inputted.

Along with the scaling filter processing, a parameter for video process, for example, a parameter for contour enhancement may be switched with the change of the effective data area 5.

The present invention brings about the same effect as the first embodiment and can subject the extracted effective data to the video process such as the scaling filter processing in which, even if the effective data area is different in size, a video quickly adapting change in the size is displayed.

### Third Embodiment

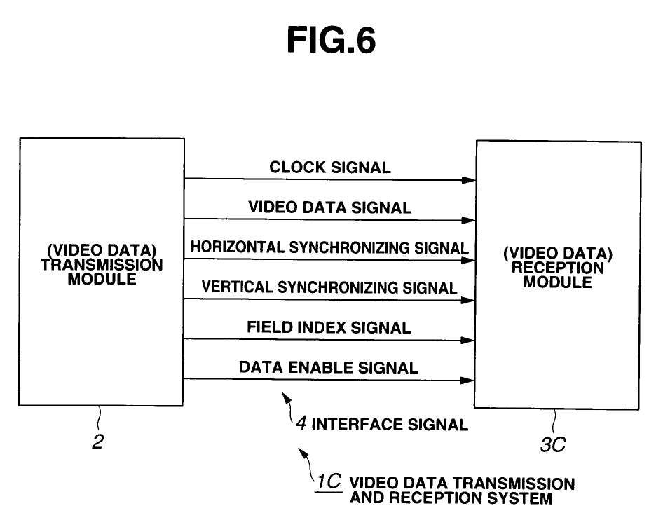

A third embodiment of the present invention is described below. FIG. 6 is a block diagram illustrating the configuration of a video data transmission and reception system 1C equipped with a reception module 3C as a video data reception apparatus according to a third embodiment of the present invention.

The video data transmission and reception system 1C connects the transmission module 2 to the reception module 3 in the video data transmission and reception system 1 of FIG. 1 through the interface signal 4 including a data enable signal.

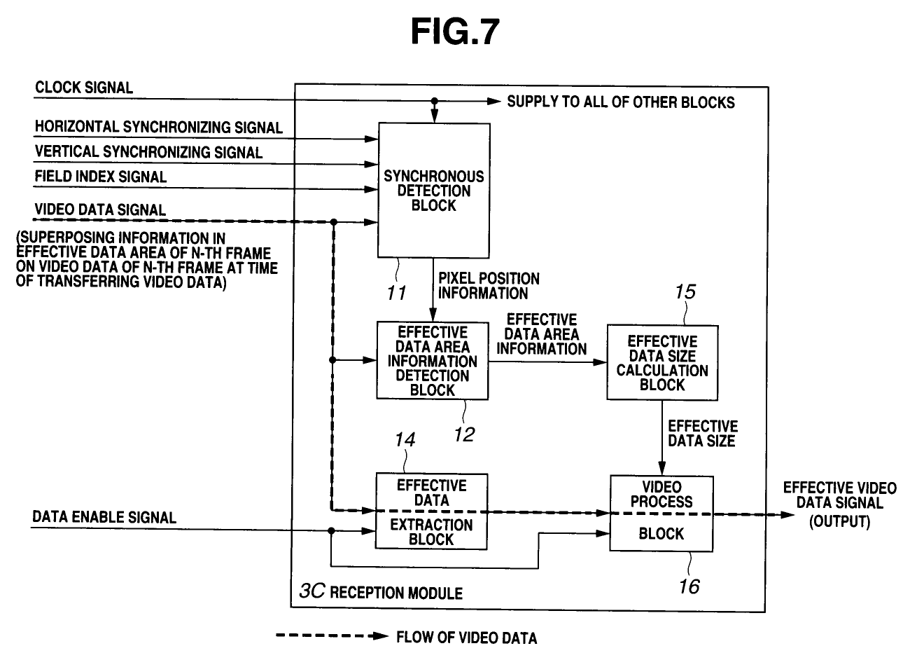

FIG. 7 is a block diagram illustrating the configuration of the reception module 3C according to the third embodiment. The reception module 3C does not include the effective data determination block 13 provided in the reception module 3B of FIG. 5. The data enable signal is inputted to the effective data extraction block 14 and the video process block 16.

The synchronous detection block 11, the effective data area information detection block 12 and the effective data size calculation block 15 operate in the same manner as in the second embodiment.

The effective data extraction block 14 detects (has a function of a data enable signal detection unit) whether there exists the data enable signal that is inputted with the video data and that the video signal is effective, i.e., that corresponds to a determination signal in which the video data is effective and extracts the effective data using the detected determination signal if the data enable signal is detected.

The video process block 16 processes the effective data supplied from the effective data extraction block 14 using the effective data size transmitted from the effective data size calculation block 15.

Thereby, the present embodiment can extract the effective data even when the effective data is intermittently sent and recognize the size of the effective data area before receiving the effective data, so that the video process such as the scaling filter can be continuously performed after the extraction of the effective data.

In the above described embodiment, although the effective data area information is used as the specific data for description, information on specific data such as a screen frequency (i.e., a field or a frame frequency), information on a parameter for the video process such as filter control and data for repeat processing of a frame may be superposed on the video data in addition to the effective data area information.

Information on the extracted specific data can be extracted on the reception module side and subjected to the video process such as the scaling filter.

FIG. 8 illustrates a modified example of a reception module 3D. In this case, the transmission module 2 in FIG. 6 superposes information on specific data excluding the effective data area on the video data signal and transmits the information.

For this reason, information on specific data excluding the effective data area is superposed instead of information in the effective data area on the video data signal inputted to the modified example of a reception module 3D, for example, on the N-th frame in FIG. 7.

The reception module 3D uses a specific data information detection block 12′ instead of the effective data area information detection block 12 in FIG. 7 and a specific data calculation block 15′ instead of the effective data size calculation block 15 in FIG. 7.

In that case, information on specific data is information such as a screen frequency (i.e., a field or a frame frequency) and a parameter for video process used for video data process (or video process). The specific data calculation block 15′ outputs, for example, specific data or setting parameters to the video process block 16.

The present modified example brings about substantially the same effect as in the case where the effective data area in the third embodiment is replaced by the specific data, for example.

The configuration in FIG. 8 uses the data enable signal, so the effective data extraction block 14 extracts the effective data area based on the data enable signal.

If information on specific data is a screen frequency (i.e., a field or a frame frequency), it may be switched at the timing of switching from a field or a frame in which information changing the screen frequency (i.e., a field or a frame frequency) is acquired to the following field or frame.

The modified example in FIG. 8 is applicable to the configuration where the data enable signal is not used, i.e., to that in FIG. 3 or FIG. 5.

In order that the modified example in FIG. 8 can flexibly adapt to information on specific data superposed on the video data signal, the specific data information detection block 12′ as the information acquisition unit may include the discrimination unit 21 configured to discriminate the kind code Ik representing the kind of the specific data.

Providing the reception module 3D with the discrimination unit 21 enables flexible adaptation to information on a different kind of specific data to be transmitted on the transmission side.

In addition, providing the reception module 3D with the discrimination unit 21 enables flexible adaptation to information on a plurality of different kinds of specific data to be transmitted on the transmission side.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A video data reception apparatus comprising:
a position information detection unit configured to detect position information on a frame or a field of a video data signal with reference to a synchronizing signal synchronous with the video data signal, the video data signal being inputted to the position information detection unit with information superposed on the video data signal, the information being on specific data of at least one of an effective video data area, a frame or a field frequency and a parameter for video process; and
an information acquisition unit configured to acquire information on the specific data from the video data signal using the position information; wherein
the information acquisition unit is capable of starting at least one piece of signal processing of the extraction of an effective video data area in the video data signal, the change of the frame or the field frequency and the change of a parameter for video process, using the information on the specific data acquired by the information acquisition unit, during the frame or the field, or by the following frame or field with respect to which the information acquisition unit acquires information on the specific data.

2. The video data reception apparatus according to claim 1, further comprising:
an effective data determination unit configured to determine as to whether video data in the effective video data area corresponding to information on the effective video data area is effective if the information on the specific data acquired by the information acquisition unit includes information in the effective video data area.

3. The video data reception apparatus according to claim 1, further comprising:
a size calculation unit configured to calculate the size of the effective video data area if the information on the specific data includes information in the effective video data area.

4. The video data reception apparatus according to claim 2, further comprising:
a size calculation unit configured to calculate the size of the effective video data area if the information on the specific data includes information in the effective video data area.

5. The video data reception apparatus according to claim 1, further comprising:
a data enable signal detection unit configured to detect a data enable signal that is inputted in synchronization with the video data and represents whether the video data in the effective video data area is effective, if the information on the specific data includes information in the effective video data area.

6. The video data reception apparatus according to claim 2, further comprising:
a data enable signal detection unit configured to detect a data enable signal that is inputted in synchronization with the video data and represents whether the video data in the effective video data area is effective, if the information on the specific data includes information in the effective video data area.

7. The video data reception apparatus according to claim 1, further comprising:
a video process unit configured to subject the effective video data area where an extraction process of the effective video data area is performed to the video process including in relation with a scaling filter, if the information on the specific data includes information in the effective video data area.

8. The video data reception apparatus according to claim 1, wherein
the position information detection unit detects position information on the frame or the field of the video data signal with reference to the synchronizing signal and a clock signal synchronous with the synchronizing signal.

9. The video data reception apparatus according to claim 1, further comprising:
a discrimination unit configured to discriminate a kind if a discriminating code representing the kind of information on the specific data is added to information on the specific data.

10. A video data reception apparatus comprising:
a position information detection unit configured to detect position information on a frame or a field of a video data signal with reference to a synchronizing signal synchronous with the video data signal, the video data signal being inputted to the position information detection unit with information superposed on the video data signal, the information being on specific data of at least one of an effective video data area and a parameter for video process; and
an information acquisition unit configured to acquire information on the specific data from the video data signal using the position information; wherein
the information acquisition unit is capable of starting at least one piece of signal processing of the extraction of an effective video data area in the video data signal and the change of a parameter for video process, using the information on the specific data acquired by the information acquisition unit, during the frame or the field with respect to which the information acquisition unit acquires information on the specific data.

11. The video data reception apparatus according to claim 10, further comprising:
an effective data determination unit configured to determine as to whether video data in the effective video data area corresponding to information on the effective video data area is effective if the information on the specific data acquired by the information acquisition unit includes information in the effective video data area.

12. The video data reception apparatus according to claim 10, further comprising:
a size calculation unit configured to calculate the size of the effective video data area if the information on the specific data includes information in the effective video data area.

13. The video data reception apparatus according to claim 10, further comprising:
a data enable signal detection unit configured to detect a data enable signal that is inputted in synchronization with the video data and represents whether the video data in the effective video data area is effective, if the information on the specific data includes information in the effective video data area.

14. The video data reception apparatus according to claim 10, further comprising:
a video process unit configured to subject the effective video data area where an extraction process of the effective video data area is performed to the video process including in relation with a scaling filter, if the information on the specific data includes information in the effective video data area.

15. A video data transmission and reception system comprising:
a video data transmission apparatus configured to transmit a synchronizing signal and a video data signal synchronous with the synchronizing signal, the video data signal being superposed to a predetermined position thereof with information of specific data of at least one of an effective video data area, a frame or a field frequency and a parameter;
a video data reception apparatus configured to receive the video data signal transmitted from the video data transmission apparatus;
a position information detection unit configured to form the video data reception apparatus and detect position information on a current video data signal with reference to the synchronizing signal from the received video data signal; and
an information acquisition unit configured to acquire information on the specific data from the received video data signal using the position information; wherein
the information acquisition unit is capable of starting at least one piece of signal processing of the extraction of an effective video data area in the video data signal, the change of the frame or the field frequency and the change of a parameter, using the information on the specific data acquired by the information acquisition unit, during the frame or the field, or by the following frame or field with respect to which the information acquisition unit acquires information on the specific data.

16. The video data transmission and reception system according to claim 15, wherein
the video data transmission apparatus superposes information on the specific data on a predetermined position in a blanking data area except the effective video data area in a video data signal in one frame or field and transmits the information.

17. The video data transmission and reception system according to claim 15, wherein
the video data transmission apparatus transmits a clock signal synchronous with the video data signal and horizontal and vertical synchronizing signals superposed or not superposed on the video data signal along with the video data signal on which the information on the specific data is superposed to the video data reception apparatus.

18. The video data transmission and reception system according to claim 16, wherein
the video data transmission apparatus superposes information on the specific data on a predetermined position in the blanking data area advanced by at least one horizontal period or more with respect to the head position of the effective video data area and transmits the information.

19. The video data transmission and reception system according to claim 15, wherein
the video data transmission apparatus adds a discriminating code superposed on the video data signal and representing the kind of information on the specific data to information on the specific data and transmits the information.

20. The video data transmission and reception system according to claim 19, wherein
the video data reception apparatus has a discrimination unit configured to discriminate the discriminating code.
